(19) United States
(12) Patent Application Publication
(10) Pub. No.: US 2005/0053362 A1
(43) Pub. Date: Mar. 10, 2005

(54) Method of adaptively inserting karaoke information into audio signal and apparatus adopting the same, method of reproducing karaoke information from audio data and apparatus adopting the same, method of reproducing karaoke information from the audio data and apparatus adopting the same, and recording medium on which programs realizing the methods are recorded

(75) Inventor: Arora Manish, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 10/936,653

(22) Filed: Sep. 9, 2004

(30) Foreign Application Priority Data
Sep. 9, 2003 (KR) 10-2003-0063361

(51) Int. Cl. H04N 5/76; G11B 27/00

(52) U.S. Cl. 386/96; 386/98

(57) ABSTRACT

A method for adaptively inserting karaoke information into an audio signal, a method for reproducing the inserted karaoke information and an apparatus therefore, and a recording medium on which programs are recorded for realizing the same. The method of adaptively inserting additional information into input audio data includes inserting karaoke information into input audio data in sub-audio block units that have a predetermined length, and wherein the karaoke information includes duration information and karaoke data and the duration information indicates the range of the sub-audio block in which the karaoke information is inserted.

### BACKGROUND OF THE INVENTION

This application claims priority from Korean Patent Application No. 2003-63361, filed on Sep. 9, 2003, in the Korean Intellectual Property Office, the disclosure of which is incorporated herein in its entirety by reference.

1. Field of the Invention

Methods and apparatuses consistent with the present invention relate to utilizing karaoke from information recorded on an audio CD and a method of using the same, and more particularly to a method of inserting karaoke information into audio data and a method of reproducing audio data in which karaoke information is inserted.

2. Description of the Related Art

In the last 20 years, much progress has been made in systems and equipment for karaoke. Karaoke was carried out through the use of analog tapes in the early 1980s. The problem with analog tapes was the inability to locate the beginning of a song immediately. The development of CD technology solved the issue of locating the beginning of the song along with offering video scenes to create an atmosphere suitable to each song. Using technological innovation such as video discs, laser discs, and CD graphics, karaoke has grown to be a major entertainment industry.

The most popular format used for karaoke is a CD+G format. The CD+G format is a standard audio CD with graphic commands added to a normally unused sub-code area of the audio CD. A player interprets graphics as the audio is played to display and highlight the lyrics or display simple logos or images. However, the down side of such a method is that in order to decode CD+G a specialized device is needed. The most popular file format for computer-based karaoke is the karaoke MIDI format (KMF). This format combines a MIDI (Musical Instrument Digital Interface) file and lyrics and makes it possible to sing along on a computer. In addition, a similar CD+MIDI computer disc format uses the CD+G method.

Compact discs have been used since 1982. Optical discs are compact and reliable not only for music but for other applications as well. Even though DVDs have become popular, CDs are still widely used for audio. Early audio CDs were designed to store stereo audio of high sound quality for a length of one hour. However, recent CDs can save high quality stereo audio for up to 80 minutes. The audio is saved in a digital format so that noise, associated with vinyl and cassettes, is virtually non-existent. In addition, a CD cannot be worn out by mere common use.

In 1984, a CD-ROM standard for computer data storage was standardized. Later on, various formats including CD-ROM XA, CD-1, improved CD, and video CD were proposed. These compact discs are physically the same as audio CDs. However, on the compact discs different data is stored such as text, image, and video data. Such multi media discs have a special disc format which can be read by certain hardware such as personal computers and video games. Applications for such discs include video games, video on CD, educational programs, and encyclopedia programs.

FIG. 1 illustrates an audio CD data storage format.

A method of storing data on an audio CD will be described referring to FIG. 1.

When recording audio data as pits in a disc, the audio data is divided into six samples per channel, that is, groups of 192 bits (6×2×16) or 24 bytes. Then, a four-byte sub-code channel and eight-byte cross-interleaved Reed-Solomon code (CIRC) parity data are added to the divided audio data shown in FIG. 1, forming a frame of 36 bytes. One block of recorded audio data is composed of 98 audio frames. FIG. 1 illustrates such an audio CD data storage format.

Each block is composed of 2352 bytes and 75 blocks per second are read from the CD at normal speed. Therefore, discs that store 74 minutes worth of data can store 333,000 blocks (74×60×75).

A 36-byte frame is composed of three-byte synchronization data, a one-byte sub-code data, a 24-byte audio data indicating six samples of the respective stereo channels, and an eight-byte parity bit for CIRC error correction. These data are interleaved with audio data within blocks.

In a CIRC method, two dimensional parity information bits are added to correct an error, and data is interleaved on the disc to protect data from burst error. Burst error up to a maximum of 3500 bits (2.4 mm) is corrected in the CIRC method, which is an adequate way to protect data from up to 12,000 bits (8.5 mm) of burst error which can be created by a slight scratch. CD-ROM discs generally implement an additional error protection method.

For example, the eight to fourteen modulation (EFM) method modulates each eight-bit symbol into 14 bits+3 merging bits, that is, 17 bits. EFM data is used to limit the pit length and space on the disc. The pit and land length of the merging bit should be larger than 3 channel bits and less than 11 channel bits. This reduces other distortions related to jitter and error rate. A P-channel indicates the start and end of each track and is a channel used by simple audio players, which do not decode an entire Q channel. The Q-channel includes time code involving minutes, seconds, and frames, table of contents (TOC) of a lead in area, track type, and catalogue number. Channel R through W are sub-codes for CD text accompanied by graphic, known as CD-G, and main audio data.

When CDs were first developed, sub-code was used to keep control data on discs. The main channel was for only audio data, and was not used for other types of data. Later on, the main channel started to be used for other types of data, and a new DVD standard omitted sub-code channels used in CDs.

CD graphics is an extension of CD audio that includes data regarding graphics and text. This enables the addition of very simple CD-ROM features to typical CD audio discs.

The data storing mechanism of an audio CD will be described below. Graphics and text can be displayed while reproducing audio, while additional data, which can be included in sub-code channels R through W, account for only 3% of the capacity of a typical CD-ROM. The maximum data rate that can be used in each of sub channels R through W is 5.4 KB/s. Data in sub channels R through W is protected by the Reed-Solomon error correction code like the audio data of the main channel.

Karaoke is one of the applications that uses CD-G. CD-G karaoke equipment with CD hi-fi can also be used. Such equipment needs three additional television sets to display text, which is the lyrics of a song. However, a specialized sub-code region is required to replay CD-G encoded on a CD-ROM. CD-G defines two additional modes, which are a musical instrument digital interface (MIDI) and a user mode.

The MIDI mode provides a maximum data channel of 3.125 kb/s for MIDI data according to the regulation of the international MIDI association. The user mode is applied to professional application. However, in order to realize karaoke, a specialized player is required to replay such a karaoke format.

### SUMMARY OF THE INVENTION

Provided is an apparatus and a method for adaptively inserting karaoke information into an audio signal to realize karaoke on existing audio players and to realize karaoke within the range in which listeners do not perceive deterioration in the sound quality of the audio signal.

Also provided are an apparatus and a method for obtaining karaoke from information recorded on an audio CD and a method of using the same.

According to an exemplary embodiment of the present invention, there is provided a method of adaptively inserting karaoke information into input audio data including inserting karaoke information into input audio data in sub-audio block units having predetermined lengths, wherein the karaoke information comprises duration information and karaoke data, and the duration information indicates the range of the sub-audio blocks in which the karaoke information is inserted.

According to another exemplary embodiment of the present invention, there is provided a computer readable recording medium storing a program for inserting karaoke information into input audio data, the program including inserting karaoke information into input audio data in sub-audio block units having predetermined lengths, and wherein the karaoke information comprises duration information and karaoke data, and the duration information indicates the range of sub-audio blocks in which the karaoke information is inserted.

According to another exemplary embodiment of the present invention, there is provided an apparatus for inserting karaoke information into input audio data including a karaoke information insertion unit, which inserts karaoke information into the input audio data in sub-audio block units having predetermined lengths wherein the karaoke information comprises duration information and karaoke data and the duration information indicates the range of the sub-audio block in which the karaoke information is inserted.

According to another exemplary embodiment of the present invention, there is provided a method of reproducing karaoke information inserted into input audio data information, including detecting synchronization information from the input audio data, extracting duration information by sub-audio block units with predetermined lengths when the detected synchronization information is valid, and extracting karaoke data from the sub-audio block based on the extracted duration information, wherein the karaoke information comprises the duration information and the karaoke data and the duration information indicates the range of the sub-audio blocks in which the karaoke information is inserted

According to another exemplary embodiment of the present invention, there is provided a computer readable recording medium storing a program for reproducing karaoke information inserted into input audio data, the program includes extracting synchronization information from input audio data, extracting duration information in sub-audio block units having predetermined lengths when the extracted synchronization information is valid, and extracting karaoke data from the sub-audio block based on the extracted duration information, wherein the karaoke information comprises the duration information and the karaoke data and the duration information indicates the range of sub-audio block in which the karaoke information is inserted.

According to another exemplary embodiment of the present invention, there is provided an apparatus for reproducing karaoke information inserted into input audio data including a synchronization detection unit, which detects synchronization information from the input audio data, and a karaoke information detection unit which extracts duration information in sub-audio block units having a predetermined length and extracts karaoke data from the sub-audio block based on the extracted duration information when the detected synchronization information is valid, wherein the karaoke information includes the duration information and the karaoke data, and the duration information indicates the range of the sub-audio block in which the karaoke information is included.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an audio CD data storage format;

FIG. 2 illustrates a bit-robbing method according to an exemplary embodiment;

FIG. 3 is a block diagram illustrating an apparatus for adaptively inserting karaoke information according to an exemplary embodiment;

FIG. 4 illustrates a structure of a lyrics data packet generated by a karaoke information data packet producing unit of FIG. 3;

FIG. 5 illustrates a structure of an MIDM data generated by the karaoke information data packet producing unit of FIG. 3;

FIG. 6 is a block diagram of a scrambler of a data packet randomization unit of FIG. 3;

FIG. 7 is a flow chart illustrating a method of adaptively inserting karaoke information according to an exemplary embodiment;

FIG. 8 is a block diagram illustrating a karaoke information-reproducing device according to an exemplary embodiment;

FIG. 9 is a block diagram of a descrambler of a synchronization information detection unit of FIG. 8;

FIG. 10 is a flow chart illustrating a method of reproducing karaoke information according to an exemplary embodiment;

FIG. 11 is a block diagram illustrating a karaoke information reproducing device according to another exemplary embodiment; and

FIG. 12 is a flow chart illustrating a method of reproducing karaoke information according to another exemplary embodiment.

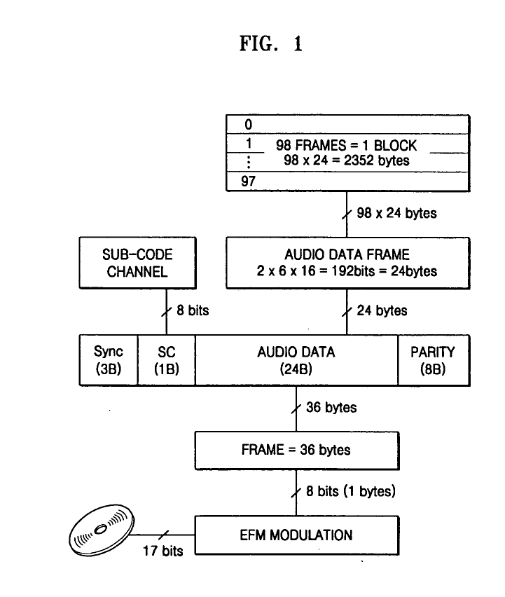

### DETAILED DESCRIPTION OF EXEMPLARY, NON-LIMITING EMBODIMENTS

Exemplary, non-limiting embodiments are described below with reference to the attached drawings.

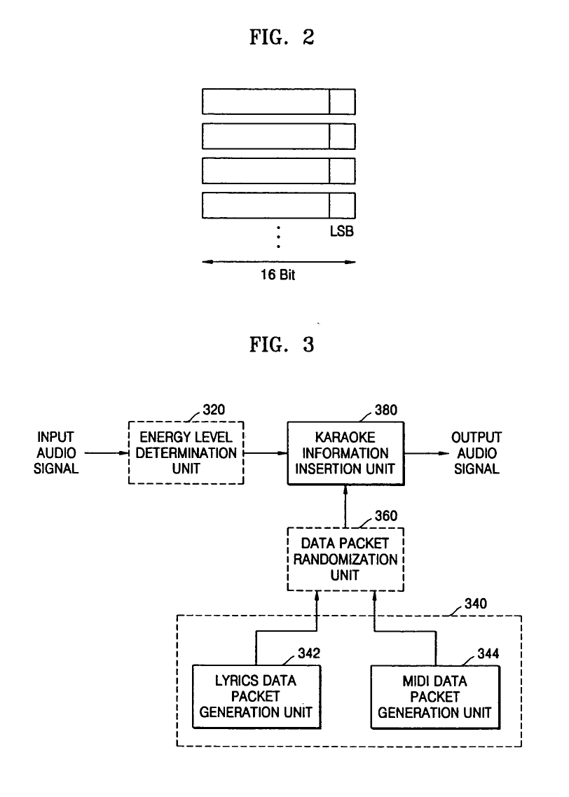

FIG. 2 illustrates a bit-robbing method according to an embodiment of the present invention.

In the present embodiment the bit-robbing method is used to insert MIDI information such as lyrics and/or karaoke information into an audio data PCM sample of an audio CD. That is, in audio encoded in pulse code modulation (PCM), a least significant bit (LSB) of an audio sample has a negligible effect on the sound quality. Therefore, even with a change in the least significant one or two bits of the PCM sample, which is shown in FIG. 2, deterioration in sound quality due to a modified PCM sample is not perceived.

FIG. 3 is a block diagram of an encoder for inserting karaoke information into an input audio signal according to an embodiment of the present invention. Referring to FIG. 3, the encoder includes an energy level determination unit 320, a karaoke information data packet-generation unit 340, and a karaoke information insertion unit 380. The karaoke information data packet-generation unit 340 includes a lyrics data packet-generation unit 342 and an MIDI data packet-generation unit 344. When an insertion pattern of inserting karaoke information between the encoder and a decoder is known, the energy level determination unit 320 may be omitted.

The energy level determination unit 320 calculates the energy of the input audio signal in audio block units, which have predetermined lengths. According to the present embodiment, the length of the audio block is 30-50 msec. A standard block length determination unit (not shown) can be included to adaptively determine the audio block length according to the characteristics of the input audio signal.

The calculated energy is compared with a predetermined threshold value and the energy level of the input audio signal is determined. In the present embodiment, the energy level of the predetermined audio frame is classified into low, intermediate, or high using a first reference value and a second reference value.

In the present exemplary embodiment, the number of bits of karaoke information to be inserted is determined according to the energy of the input audio signal calculated by the energy level determination unit 320.

For example, when the energy of the input audio signal is lower than the first reference value, that is, when the energy is low, the signal cannot mask noise generated by an inserted bit, that is, a bit-robbing bit. Therefore, karaoke information is not inserted into a stream. In other words, karaoke information is not inserted into the stream since a user can perceive the noise generated by the inserted bit.

When the energy of the current audio block is larger than the first reference value and smaller than the second reference value, that is, when the energy is at an intermediate level, if one least significant bit (LSB) is used to insert karaoke information, noise caused by a bit-robbing bit is masked. That is, the noise caused by an inserted bit is not perceived by listeners and can therefore be used as a hidden information channel. Therefore, in the present embodiment, karaoke information is inserted into the least significant bit of a PCM sample when the energy level is intermediate as shown in FIG. 2.

When the energy of the current audio block is greater than the second reference value, that is, when the energy level is high, karaoke information is inserted using an LSB of two bits per PCM sample as shown in FIG. 2 for the same reason as in the case of the intermediate level.

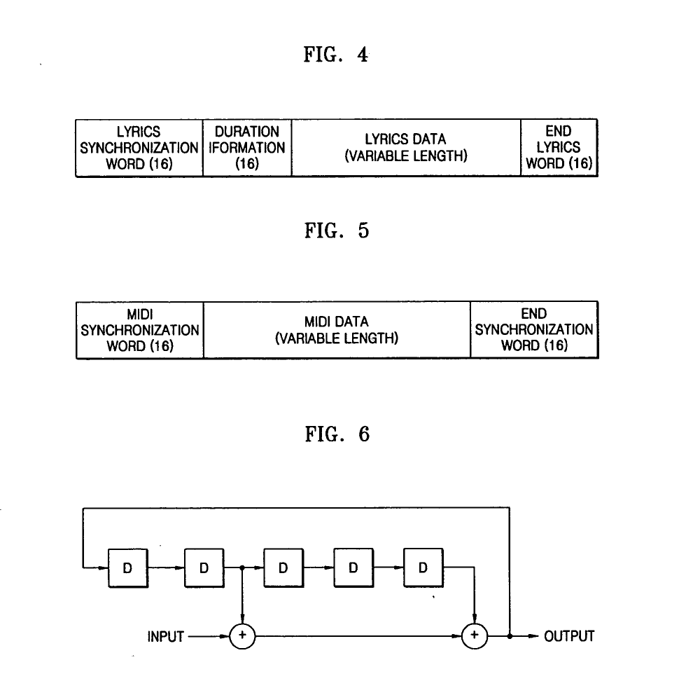

As an option, as will be mentioned with reference to FIG. 4, by using duration information, which indicates a duration when karaoke information is inserted, it is possible to omit the process of calculating the energy of the current audio block in the encoder and the decoder.

It may be important to adaptively determine the location and number of the bit-robbing bits so that the modified PCM samples, which are modified in the bit-robbing method, are perceptually similar to the original audio.

For the intermediate and high-energies, even when reducing one and two bits respectively in the active range, noise deterioration due to such reduction is barely perceived. This is because the karaoke information data packet uses 5% to 10% of the common audio bit stream.

For example, when assuming one bit is bit-robbed for 5% of the time and two bits are bit-robbed for 3% of the time, the number of bits that are available for bit-robbing is 9702 bits per second, that is (5×1×44100×2+3×2×44100×2)/100. This bit rate can be applied to various applications.

Karaoke data is inserted in the form of a data packet, which can be classified into two types. One type is for lyrics data and the other is a karaoke midi format (KMF) packet. Lyrics data packets, which are inserted into the audio signal and MIDI data packets, are produced in the karaoke information data packet producing unit 340.

FIG. 4 illustrates the structure of a lyrics data packet produced by the karaoke information data packet producing unit 340. The lyrics data packet includes a 16-bit lyrics synchronization word, 16-bit duration information, lyrics data of variable length, and a 16-bit end synchronization word.

The 16-bit lyrics synchronization word is included in the first 16 bits of a packet. 16 bits is long enough for a start code and the probability of false detection is very low. The lyrics synchronization word indicates that when the energy of the signal is intermediate or high the lyrics data will be inserted into the least significant one or two bits of the PCM sample. In the present embodiment, the lyrics synchronization word is inserted in the least significant one bit of the PCM sample even when the energy level is high.

Duration information data is included in the 16 bits after the lyrics synchronization word. The number of samples bit-robbed and the current lyrics data indicate the valid duration, that is, time.

Information regarding the number of bit-robbed samples in the duration information takes into account the event in which bit-robbing is not performed on the samples after the predetermined karaoke information is inserted when the energy is at an intermediate or high level. In the present exemplary embodiment the duration information data is inserted in the least significant one bit of the PCM sample.

It is possible to insert karaoke information and reproduce karaoke information without the process of determining the energy level in the encoder and decoder unit by selectively using duration information and inserting karaoke information using the bits selected by sub-audio block units, for example, the least significant bit. Furthermore, the valid duration of the current lyrics data, which is included in the duration information, enables the highlighting of the lyrics of a current replay location on the karaoke screen.

Lyrics data are inserted into the least significant one or two bits of the PCM sample when the energy level is intermediate or high. In the present exemplary embodiment, when the energy level is high, the lyrics data is inserted into the least significant two bits. However, as an option, it is possible to use only one least significant bit. The 16-bit end synchronization word indicates that all of the lyrics data packets are inserted.

One advantage of the information insertion method using bit-robbing according to the present embodiment is that synchronization with audio data is guaranteed. By inserting lyrics data into bit-robbed bits, that is, by adding lyrics information to audio data itself, lyrics have the advantage of being inserted into an audio stream without having to take into account problems relating to audio synchronization when the lyrics are displayed.

If a separate data channel has to be formed for audio synchronization, it is necessary to use a large number of bits to transmit timing information. Therefore, the information insertion method of the present embodiment has the advantage of being able to effectively use the channel.

FIG. 5 illustrates the structure of the MIDI data packet produced by the karaoke information data packet producing unit 340. The format of the MIDI data packet is the same as that of a lyrics data packet except that the duration information data is not included. Duration information is not included separately since it is already included in different MIDI track data when using the MIDI format. Since the MIDI data packet is reproduced simultaneously with audio data, synchronization with audio data is unnecessary. However, MIDI data presented before the present time should be inserted into the audio data beforehand.

As an option, it is possible to randomise the lyrics data packet and/or MIDI data packets produced by the karaoke information data packet producing unit 340 and output randomised lyrics data packets and/or MIDI data packets to the karaoke information insertion unit 380. The randomised karaoke information data packet inserted into the PCM sample functions as a dither signal for the most significant bit (MSB).

FIG. 6 is a block diagram of a scrambler using a feedback shift register to randomise data packets in the data packet randomisation unit 360 shown in FIG. 3.

The karaoke information insertion unit 380 inserts karaoke information received from the karaoke information data packet-generation unit 340 into the audio signal in sub-audio blocks, for example, PCM sample units. For example, when the energy level of the current audio block calculated by the energy level determination unit 320 is low, insertion of karaoke information is skipped.

When the energy level of the current audio block calculated by the energy level determination unit 320 is intermediate, karaoke information is inserted into sub-audio blocks according to a first insertion pattern. For example, the first insertion pattern refers to the method of inserting the data of the lyrics and the MIDI data packet illustrated in FIGS. 4 and 5 using the least significant bit of the PCM sample of the current audio block.

Furthermore, when the energy level of the audio block is high, karaoke information is inserted into sub-audio blocks according to a second insertion pattern. For example, the second insertion pattern refers to the method of inserting the data of the lyrics and MIDI data packet illustrated in FIGS. 4 and 5 using the least significant bit of the PCM sample of the current audio block.

When the energy levels of the audio blocks are low for an extended period, karaoke information is inserted according to a third insertion pattern. For example, the third insertion pattern uses the least significant bit among the even numbered PCM samples of the current audio block. Then, the audio data inserted into the karaoke information data packet is recorded on the audio CD track.

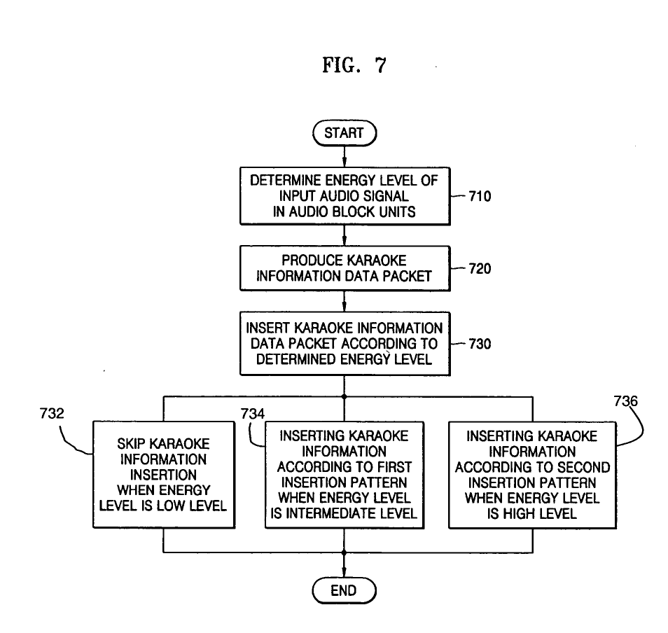

FIG. 7 is a flow chart illustrating an operation carried out in the encoder of FIG. 3 to adaptively insert karaoke information according to the energy level of the input audio signal. In step 710, the energy level of the inputted audio signal is determined by a predetermined frame interval. According to the present embodiment, the energy level of the audio frame is classified as low, intermediate, or high.

In step 720, karaoke information data packets, which will be inserted into the audio signal, are produced. According to the present embodiment, a lyrics data packet and a MIDI data packet, which are shown in FIGS. 4 and 5 are produced.

In step 730, taking into account the energy level determined in step 710, the karaoke information data packet produced in step 720 is inserted into the audio signal in sub-audio block units. For example, in step 732 when the energy level of the current audio block is low, insertion of karaoke information is skipped. When the energy level of the current audio block is intermediate, karaoke information is inserted into the audio signal according to the first insertion pattern in step 734. When the energy level of the current audio block is high, the karaoke information is inserted into the audio signal according to the second insertion pattern in step 736.

In the present exemplary embodiment, the produced karaoke information is inserted into the audio signal without a randomising process, however it is possible to insert the selectively produced karaoke information data packet into the audio signal after the randomising process. When the energy levels of the audio blocks are continuously low for a predetermined period, the karaoke information is inserted into the audio signal according to the third insertion pattern. Next, the audio data in which karaoke information is inserted is recorded to the audio CD track.

The karaoke CD type decoder operates in two modes. In mode 1 the replay of the original audio track and the display of the synchronized lyrics are performed simultaneously. In mode 2 the replay of the karaoke MIDI file and the display of lyrics are performed simultaneously.

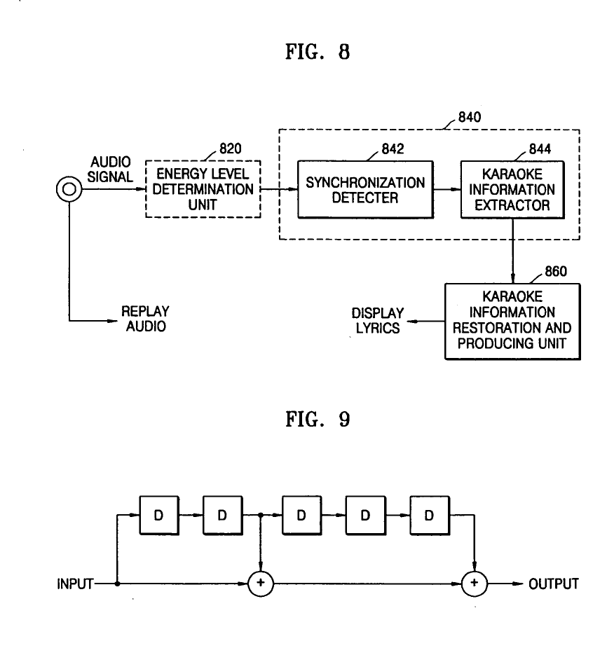

FIG. 8 is a block diagram of a decoder according to an exemplary embodiment of the present invention. The karaoke CD decoder measures the energy level of the input signal and performs the same operations as the encoder to determine which of the bits were bit-robbed from the PCM sample by the encoder. The decoder of the present exemplary embodiment operates in mode 1.

The decoder according to an exemplary embodiment includes an energy level determination unit 820, a karaoke information extraction unit 840, and a lyrics data restoration and replay unit 860. The karaoke information extraction unit 840 includes a synchronized information detection unit 842 and a karaoke information extraction unit 844. When the insertion pattern of the karaoke information is predetermined, the energy level determination unit 820 may be omitted.

The energy level determination unit 820 calculates the energy level of the input audio signal in audio block units in the same manner as the energy level determination unit 320 of the encoder shown in FIG. 3. The calculated energy level is output from the synchronized information detection unit 842.

When the energy level of the current audio block is intermediate or high, the synchronization detector 842 determines whether the synchronization word detected from the PCM sample of the current audio block and the synchronization word inserted in the encoder match. When synchronization words match the result is output to the karaoke information extractor.

When the energy levels of the predetermined number of audio blocks are continuously low, the synchronized detection unit 842 determines whether the synchronization word detected from the PCM sample of the audio block and the synchronization word inserted in the encoder are identical. When the synchronized words are identical, the result is output to the karaoke information extraction unit 844.

FIG. 9 is a block diagram of a descrambler including a feedback shift register, included in the synchronized information detection unit 820. The feedback shift register of extracts bits from the PCM samples, maintains one delay line, descrambles data of the delay line and examines the validity of the synchronization word.

The karaoke information extraction unit 844 extracts duration information and lyrics information based on the input from the energy level determination unit 820 and synchronized information detection unit 842. For example, when the energy level of the current audio block is intermediate or high, 16 bits of duration information, shown in FIG. 4, are extracted from the least significant bit of the PCM sample.

Furthermore, when the energy level of the input audio signal is intermediate and the synchronized word is extracted, lyrics information is extracted according to the first insertion pattern during the period designated by duration information. For example, according to the first insertion pattern, lyrics information is extracted from the least significant one bit of the PCM sample.

When the energy level of the input audio signal is high and a synchronized pattern is detected, lyrics information is extracted according to the second insertion pattern during the period designated by duration information. For example, according to the second insertion pattern, lyrics information is extracted from the least significant two bits of the PCM sample.

When the energy levels of the predetermined number of audio blocks are continuously low and synchronized words are identical, duration information is extracted from the least significant one bit of the PCM sample and lyrics information is extracted according to the third insertion pattern. For example, according to the third insertion pattern, lyrics information is extracted from the least significant bit of the even-numbered PCM samples of the current audio block.

The karaoke information restoration and replay unit 860 uses duration information and lyrics information extracted by the karaoke information extraction unit 844 and displays lyrics for a predetermined period. The karaoke information restoration and replay unit 860 includes a buffer (not shown) for buffering lyrics information extracted from the karaoke information extraction unit 844.

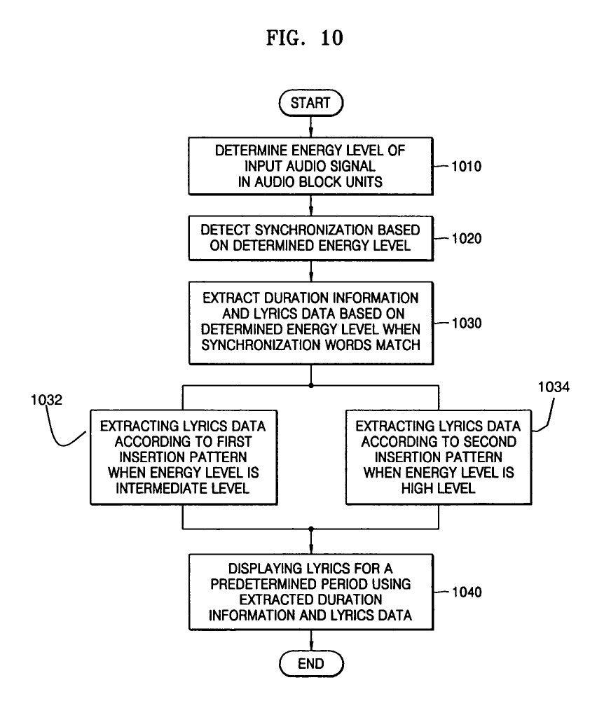

FIG. 10 is a flow chart illustrating the operation of the decoder shown in FIG. 8. In step 1010, the energy level of the input audio signal is determined by audio block units, which have predetermined lengths.

In step 1020, synchronized information is extracted based on the energy level determined in step 1010. In an exemplary embodiment, when the determined energy level is intermediate or high, it is determined whether the synchronized information matches the synchronized word input to the encoder.

When the energy levels of the predetermined number of audio blocks are continuously low, the synchronized word is extracted from the PCM samples of the current audio block and it is determined whether the synchronization word matches the synchronized word input to the encoder. In step 1030, when the synchronized words are identical, duration information and lyrics information are extracted based on the energy level determined in step 1010. For example, when the energy level of the current audio block is intermediate or high, the 16-bit duration information, which is shown in FIG. 4, is extracted from the least significant one bit of the PCM sample.

Furthermore, when the energy level of the current audio block is intermediate, lyrics information is extracted according to the first insertion pattern (step 1032) during the period designated by the duration information. When the energy level of the current audio block is high, the lyrics information is extracted according to the second insertion pattern (step 1034) during the period designated by the duration information. When the energy levels of the predetermined number of audio blocks are low for a predetermined period and synchronized patterns are identical, duration information is extracted from the least significant one bit of the PCM sample and lyrics information is extracted according to the third insertion pattern.

In step 1040, lyrics are displayed for a predetermined period using extracted duration information and lyrics information. Lyrics are replayed from the audio CD with the original audio.

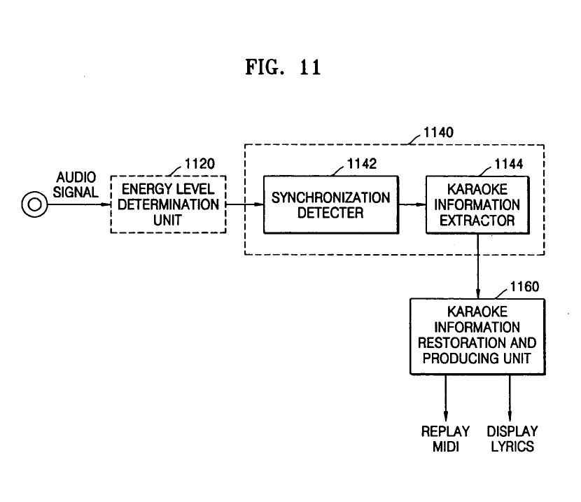

FIG. 11 is a block diagram of a decoder according to another exemplary embodiment of the present invention. The decoder according to the present embodiment includes an energy level determination unit 1120, a karaoke information detection unit 1140, and a karaoke information restoration and replay unit 1160. The karaoke information detection unit 1140 includes a synchronized information detection unit 1142 and karaoke information extraction unit 1144. When the insertion pattern of the karaoke information is predetermined, the energy level determination unit 1120 can be omitted. The decoder of the present embodiment may operate in mode 2.

The components illustrated in FIG. 11 perform the same operations that the components in FIG. 8 perform except that the karaoke information extraction unit 1144 extracts lyrics information and MIDI data, and the additional data restoration and replay unit 1160 simultaneously replays lyrics data and MIDI data. Therefore, a detailed description of common components will be skipped for the sake of brevity.

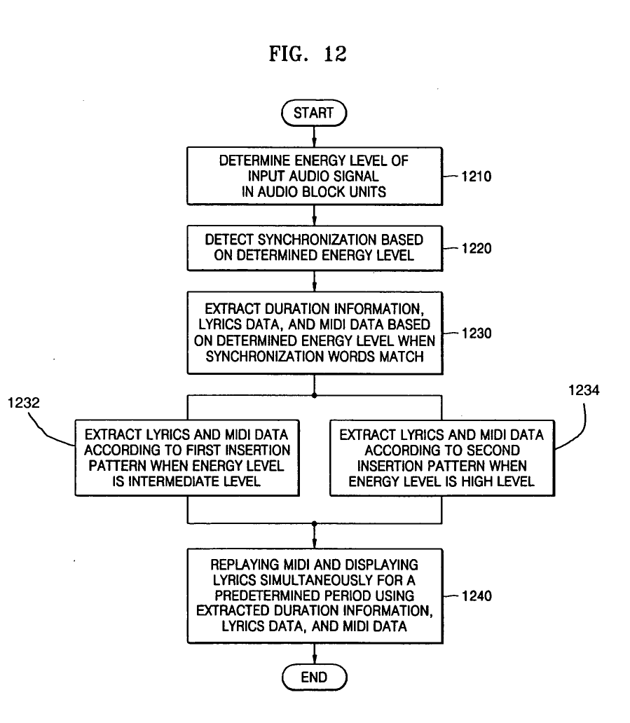

FIG. 12 is a flow chart illustrating the operation of the decoder shown in FIG. 11. The steps 1210 and 1220 illustrated in FIG. 12 are the same as the steps in FIG. 11 except that in steps 1230, 1232 and 1234 lyrics information and MIDI data are extracted, and in step 1240 lyrics data and MIDI data are replayed simultaneously. Therefore, a detailed description will be skipped for the sake of brevity.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, hard discs, floppy discs, flash memory, and optical data storage devices. The recording medium can also be in carrier wave form (e.g., transmission through the Internet). The computer readable recording medium can also be distributed over network coupled computer systems so that the computer readable code is stored and executed in a distributed fashion.

Since the karaoke information insertion method according to exemplary embodiments adaptively inserts karaoke information into audio data itself using a bit-robbed bit according to the energy level of the input audio signal, insertion of karaoke information without deterioration of audio sound quality is possible. In addition, since a separate channel is not needed, channels can be effectively used, and since there is no need to decode separate channel information, the structure of the decoder can be simplified, and, at the same time, compatibility with general CD players can be maintained.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of adaptively inserting karaoke information into input audio data, the method comprising inserting karaoke information into input audio data in sub-audio block units,
wherein the karaoke information comprises duration information and karaoke data, and the duration information indicates a range of the sub-audio block units in which the karaoke information is inserted.

2. The method of claim 1, wherein the karaoke information comprises a lyrics data packet comprising synchronization information, the duration information and the lyrics data packet, and the karaoke data is lyrics data related to the audio data.

3 The method of claim 1, further comprising:
determining energy levels of audio block units by calculating energy of the audio data in the audio block units, each of the audio block units comprising a predetermined number of the sub-audio block units; and
determining an insertion pattern used to insert the karaoke information into the sub-audio block units according to a determined energy level.

4. The method of claim 3, wherein the insertion pattern is information related to the number of bits and/or bit location of the sub-audio block units used to insert the karaoke information.

5. The method of claim 3, further comprising:
inserting the karaoke information according to a first insertion pattern when energy of a current audio block is greater than a first reference value and less than a second reference value; and
inserting the karaoke information according to a second insertion pattern when the energy of the current audio block is greater than the second reference value;
wherein the amount of the karaoke information inserted according to the second insertion pattern is greater than the amount of the karaoke information inserted according to the first insertion pattern, and the second reference value is larger than the first reference value.

6. The method of claim 3, further comprising determining a length of the audio block units according to the input audio data.

7. The method of claim 3, wherein the sub-audio block units are pulse code modulation samples.

8. The method of claim 1, wherein the karaoke information inserted into the audio data further comprises a musical instrument digital interface data packet comprising synchronization information and MIDI data.

9. The method of claim 3, wherein, when the energy levels of the audio block units are continuously lower than a first reference value, the karaoke information is inserted using a least significant bit of the sub-audio block units.

10. An apparatus for inserting karaoke information into input audio data, the apparatus comprising:
a karaoke information insertion unit inserting karaoke information into the input audio data in sub-audio block units; and
wherein the karaoke information comprises duration information and karaoke data and the duration information indicates a range of the sub-audio block units in which the karaoke information is inserted.

11. The apparatus of claim 10, wherein the karaoke information comprises a lyrics data packet comprising synchronization information, the duration information, and the karaoke data which is lyrics data related to the audio data.

12. The apparatus of claim 10, further comprising an energy level determination unit which calculates energy of the audio data by audio block units of the auto data, each of the audio block units comprising a predetermined number of the sub-audio block units, and which compares the calculated energy with a predetermined standard value, and determines an insertion pattern to be used to insert the karaoke information into the sub-audio block units.

13. The apparatus of claim 12, wherein the insertion pattern is information related to at least one of a number of bits and bit location of the sub-audio block units used to insert karaoke information.

14. The apparatus of claim 12, wherein, when the energy of a current audio block is greater than a first reference value and less that a second reference value, the karaoke insertion unit inserts the karaoke information according to a first insertion pattern, and when the energy of the current audio block is greater than the second reference value the karaoke insertion unit inserts the karaoke information according to a second insertion pattern, and the amount of karaoke information inserted according to the second insertion pattern is greater than the amount of karaoke information inserted according to the first insertion pattern, and the second reference value is greater than the first reference value.

15. The apparatus of claim 12, further comprising a standard block length determination unit which determines a length of the audio block units according to the input audio data.

16. The apparatus of claim 12, wherein the sub-audio block units are pulse code modulation samples.

17. The apparatus of claim 10, wherein the karaoke information inserted into the audio data further comprises a MIDI data packet comprising synchronization information and MIDI data.

18. The apparatus of claim 12, wherein the karaoke information insertion unit uses the least significant bit of the sub-audio block units to insert the karaoke information when the energy levels of the audio block units are continuously lower than a first reference value.

19. A method of reproducing karaoke information inserted into input audio data information, the method comprising:
detecting synchronization information from the input audio data;
extracting duration information of sub-audio block units when the detected synchronization information is valid; and
extracting karaoke data from the sub-audio block units based on the extracted duration information;
wherein the karaoke information comprises the duration information and the karaoke data and the duration information indicates a range of the sub-audio block units in which the karaoke information is inserted.

20. The method of claim 19, wherein the karaoke information includes a lyrics data packet comprising synchronization information, the duration information and the karaoke data, and wherein the karaoke information is lyrics data related to the audio data.

21. The method of claim 19, further comprising:
determining an energy level in audio block units by calculating energy of the audio data of the audio block units, each of the audio block units comprises a predetermined number of the sub-audio block units, and comparing the calculated energy with a predetermined standard value; and
determining an insertion pattern used to insert the karaoke information into the sub-audio block units based on the determined energy level.

22. The method of claim 21, wherein the insertion pattern is information related to at least one of a number of bits and bit location of the sub-audio block units used to insert the karaoke information.

23. The method of claim 21, further comprising:
extracting the karaoke information according to a first insertion pattern when energy of a current audio block is greater than a first reference value and less than a second reference value; and
extracting the karaoke information according to a second insertion pattern when the energy of the current audio block is greater than the second reference value;
wherein the amount of the karaoke information extracted according to the second insertion pattern is greater than the amount of karaoke information extracted according to the first insertion pattern, and the second reference value is greater than the first reference value.

24. The method of claim 21, further comprising determining a length of the audio block units according to the input audio data.

25. The method of claim 21, wherein the sub-audio block units are pulse code modulation samples.

26. The method of claim 19, wherein karaoke information is extracted from the audio data and comprises an MIDI data packet including synchronization information and a MIDI packet.

27. The method of claim 21, wherein, when the energy levels of a predetermined number of audio blocks are continuously less than a first reference value, karaoke information is extracted using a least significant bit of the sub-audio block.

28. An apparatus for reproducing karaoke information inserted into input audio data, the apparatus comprising:
a synchronization detection unit which detects synchronization information from the input audio data; and
a karaoke information detection unit which extracts duration information from sub-audio block units and extracts karaoke data from the sub-audio block units based on the extracted duration information;
wherein the karaoke information includes the duration information and the karaoke data, and the duration information indicates a range of the sub-audio block units in which the karaoke information is included.

29. The apparatus of claim 28, wherein the karaoke information includes a lyrics data packet comprising synchronization information, the duration information and the karaoke data, and the karaoke information is lyrics data related to the audio data.

30. The apparatus of claim 28, further comprising:
an energy level determination unit which determines energy levels of audio block units by calculating energy of the audio data in the audio block units, each of the audio block units comprising a predetermined number of the sub-audio block units; and
an insertion pattern determination unit which determines an insertion pattern used to insert the karaoke information into the sub-audio block units based on the determined energy level.

31. The apparatus of claim 30, wherein the inserted pattern is information related to at least one of a number of bits and bit location of the sub-audio block units used to insert the karaoke information.

32. The apparatus of claim 30, further comprising a karaoke information extraction unit extracting the karaoke information according to a first insertion pattern when the energy of a current audio block of the audio block units is greater than a first reference value and less than a second reference value, and extracting the karaoke information according to a second insertion pattern when the energy of the current audio block is greater than the second reference value, wherein the size of the karaoke information extracted according to the second insertion pattern is greater than the size of the karaoke information extracted according to the first insertion pattern and the second reference value is greater than the first reference value.

33. The apparatus of claim 30, further comprising a standard block length determination unit which determines a length of the audio block units according to the input audio data.

34. The apparatus of claim 33, wherein the sub-audio block units are pulse code modulation samples.

35. The apparatus of claim 28, wherein the karaoke information is extracted from the audio data and comprises an MIDI data packet including synchronization information and MIDI data.

36. A computer readable recording medium storing a program for inserting karaoke information into input audio data, the program comprising inserting karaoke information into input audio data in sub-audio block units,
wherein the karaoke information comprises duration information and karaoke data, and the duration information indicates a range of the sub-audio block units in which the karaoke information is inserted.

37. The computer readable recording medium of claim 36, wherein the karaoke information comprises synchronization information, duration information, and karaoke data in which the lyrics data packet is related to the audio data.

38. The computer readable recording medium of claim 36, wherein the program further comprises:
determining an energy level in the audio block units by calculating energy of audio data in the audio block units, each of the audio block units comprising a predetermined number of the sub-audio block units and comparing the calculated energy with a predetermined standard value; and
determining an insertion pattern used to insert the karaoke information into the sub-audio block units according to the determined energy level.

39. The computer readable recording medium of claim 38, wherein the insertion pattern is information related to a number of bits and/or bit location of the sub-audio block units used to insert the karaoke information.

40. The computer readable recording medium of claim 38, wherein the program further comprises:
inserting the karaoke information according to a first insertion pattern when energy of a current audio block of the audio block units is greater than a first reference value and less than a second reference value;
inserting the karaoke information according to a second insertion pattern when the energy of the current audio block is greater than the second reference value; and
wherein the amount of the karaoke information inserted according to the second insertion pattern is greater than the amount of the karaoke information inserted according to the first insertion pattern, and wherein the second reference value is larger than the first reference value.

41. The computer readable recording medium of claim 38, wherein, when an energy level of a predetermined number of the audio block units are continuously lower than a first reference value the karaoke information is inserted using a least significant bit of the sub-audio block units.

42. A computer readable recording medium storing a program for reproducing karaoke information inserted into input audio data, the program comprising:
extracting synchronization information from input audio data;
extracting duration information in sub-audio block units with a predetermined length when the extracted synchronization information is valid; and
extracting karaoke data from the sub-audio block units based on the extracted duration information;
wherein the karaoke information comprises the duration information and the karaoke data and the duration information indicates a range of sub-audio block units in which the karaoke information is inserted.

43. The computer readable recording medium of claim 42, wherein the karaoke information includes a data packet formed of synchronization information, the duration information, and karaoke data, and the karaoke data is lyrics data related to audio data.

44. The computer readable recording medium of claim 42, wherein the program further comprises:
determining energy levels in audio block units by calculating energy of the audio data of the audio block units, each of the audio block units comprises a predetermined number of the sub-audio block units and comparing the calculated energy with a predetermined standard value; and
determining an insertion pattern used to insert the karaoke information into the sub-audio block units based on the determined energy level.

45. The computer readable recording medium of claim 44, wherein the insertion pattern is information related to a number of bits and/or bit location of the sub-audio block units used to insert the karaoke information.

46. The computer readable recording medium of claim 44, wherein the program further comprises:
extracting the karaoke information according to a first insertion pattern when energy of a current audio block of the audio block units is greater than a first reference value and less than a second reference value; and
extracting the karaoke information according to a second insertion pattern when the energy of the current audio block is greater than the second reference value; and
wherein the amount of the karaoke information extracted according to the second insertion pattern is greater than the amount of the karaoke information extracted according to the first insertion pattern, and the second reference value is larger than the first reference value.

47. The computer readable recording medium of claim 44, wherein when the energy levels of a predetermined number of the audio block units are continuously less than a first reference value, the karaoke information is extracted using a least significant bit of the sub-audio block units.
